(19) United States
(12) Patent Application Publication
(10) Pub. No.: US 2012/0246898 A1
(43) Pub. Date: Oct. 4, 2012

(54) CIRCULAR SAW REPLACEMENT PART KIT

(76) Inventor: Gerald LEWIS, Monroe, WA (US)

(21) Appl. No.: 13/074,462

(22) Filed: Mar. 29, 2011

(51) Int. Cl. B23Q 1/00

(52) U.S. Cl. 29/283

(57) ABSTRACT

The present invention is a circular saw replacement part kit that replaces specific parts of a circular saw when they break. The specific replacement parts include a steel depth lock with a distal end that includes a hex nut aperture disposed on the distal end to adjust the circular saw cutting depth and a steel angle lock lever with a distal end that includes a hex nut aperture to secure the circular saw desired cutting angle. The kit also includes a steel blade guard thumb grip to facilitate grasping a blade guard.

### TECHNICAL FIELD & BACKGROUND

Frequently, fundamental parts of a circular saw deteriorate and break-off, causing a safety hazard. Repairing these parts involves the use of repair shops that can take several days to refurbish the broken part, costing the user valuable time.

The present invention generally relates to a replacement part kit. More specifically, the invention is a circular saw replacement part kit.

It is an object of the invention to provide a replacement part kit that offers substitute parts for frequently damaged components of a circular saw.

It is an object of the invention to provide a replacement part kit that promptly provides common substitute parts for a circular saw that saves time and stress at home or on a job site.

What is really needed is a replacement part kit that promptly provides common substitute parts for a circular saw that saves time and stress at home or on a job site.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead perspective view of a replacement part kit, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

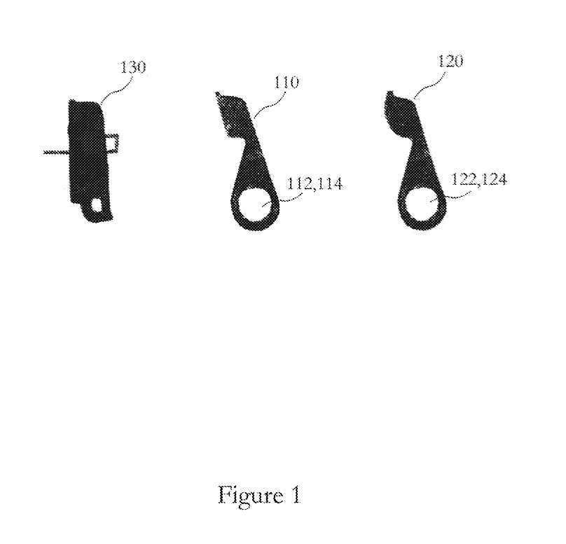

FIG. 1 illustrates an overhead perspective view of a replacement part kit 100, in accordance with one embodiment of the present invention. The replacement part kit 100 is a set of replacement parts for commonly broken parts on a circular saw (not shown). The replacement part kit 100 includes a depth lock 110 with a hex nut aperture 112, an angle lock lever 120 with a hex nut aperture 122 and a blade guard grip 130 as the replacement parts.

The depth lock 110 adjusts how deeply the blade of the circular saw will cut into the desired cutting surface. There is a hex nut aperture 112 disposed on a distal end 114 of the depth lock 110 to accommodate and fasten any suitable size hex nut. The angle lock lever 120 lets a user secure a desired cutting angle for the circular saw. There is also a hex nut aperture 122 disposed on a distal end 124 of the angle lock lever 120 to accommodate and fasten any suitable size hex nut. The blade guard grip 130 is a thumb grip type of blade guard grip to facilitate grasping a blade guard (not shown).

When necessary, the user simply replaces any broken depth lock 110, angle lock lever 120 or blade guard grip 130 with the depth lock 110, angle lock lever 120 or blade guard grip 130 of a circular saw from the replacement part kit 100, saving time and stress at home or on the job site. The replacement part kit 100 is uniquely designed to be safe, durable, compact, easy to use, and economical. The depth lock 110, angle lock lever 120 and the blade guard grip 130 are approximately ½″ wide and 2″ long and are made of steel, although the depth lock 110, angle lock lever 120 and the blade guard grip 130 can be made of other suitable materials and be of any suitable dimension.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A circular saw replacement part kit to repair a damaged circular saw, comprising;
a depth lock with a distal end to adjust said circular saw cutting depth;
an angle lock lever with a distal end to secure said circular saw desired cutting angle; and
a blade guard grip to facilitate grasping a blade guard.

2. The kit according to claim 1, wherein said depth lock has a hex nut aperture disposed on said distal end to accommodate and fasten a hex nut.

3. The kit according to dam 2, wherein said depth lock is made of steel.

4. The kit according to claim 1, wherein said angle lock lever has a hex nut aperture disposed on said distal end to accommodate and fasten a hex nut.

5. The kit according to claim 4, wherein said angle lock lever is made of steel.

6. The kit according to dam 1, wherein said blade guard grip is a blade guard thumb grip.

7. The kit according to claim 6, wherein said blade guard grip is made of steel.

8. The kit according to claim 7, wherein said blade guard grip is approximately ½″ wide and 2″ long.

9. A circular saw replacement part kit to repair a damaged circular saw, comprising;
a depth lock with a distal end that includes a hex nut aperture disposed on said distal end to adjust said circular saw cutting depth;
an angle lock lever with a distal end that includes a hex nut aperture to secure sad circular saw desired cutting angle; and
a blade guard thumb grip to facilitate grasping a blade guard.

10. The kit according to claim 9, wherein said depth lock is made of steel.

11. The kit according to claim 10, wherein said depth lock is approximately ½″ wide and 2″ long.

12. The kit according to claim 9, wherein said angle lock lever is made of steel.

13. The kit according to claim 12, wherein said angle lock lever is approximately ½″ wide and 2″ long.

14. The kit according to claim 9, wherein said blade guard grip is made of steel.

15. A circular saw replacement part kit to repair a damaged circular saw, comprising;
a steel depth lock with a distal end that includes a hex nut aperture disposed on said distal end to adjust said circular saw cutting depth;
an angle lock lever with a distal end that includes a hex nut aperture to secure said circular saw desired cutting angle; and
a blade guard thumb grip to facilitate grasping a blade guard.

16. The kit according to claim 15, wherein said depth lock is approximately ½″ wide and 2″ long.

17. The kit according to claim 16, wherein said angle lock lever is made of steel.

18. The kit according to claim 15, wherein said angle lock lever is approximately ½″ wide and 2″ long.

19. The kit according to claim 15, wherein said blade guard grip is made of steel.

20. The kit according to claim 19, wherein said blade guard grip is approximately ½″ wide and 2″ long.
